(19) United States
(12) Patent Application Publication
(10) Pub. No.: US 2010/0053427 A1
(43) Pub. Date: Mar. 4, 2010

(54) PICTURE IMPROVEMENT SYSTEM

(76) Inventor: Masafumi D. Naka, Irvine, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/551,910

(22) Filed: Sep. 1, 2009

Related U.S. Application Data
(60) Provisional application No. 61/093,385, filed on Sep. 1, 2008.

(51) Int. Cl. H04N 7/01

(52) U.S. Cl. 348/450; 348/E07.003

(57) ABSTRACT

Systems and methods for effectively enhancing television pictures by correcting line separation effect due to errors in interlace to progressive conversion of a program signal.

### CROSS-REFERENCE TO RELATED APPLICATION

This application claims the benefit of provisional application Ser. No. 61/093,385 filed Sep. 1, 2008, which is fully incorporated herein by reference.

### FIELD

The present invention relates generally to televisions and, more particularly, to systems and methods that facilitate picture improvement through enhanced interlace to progressive conversion.

### BACKGROUND

To convert interlaced signal to progressive signal, most systems utilize a three dimensional interlace-to-progressive (3DIP) conversion method shown in FIG. 7. In accordance with this method, if “motion” is detected in the picture, a two dimensional interlace-to-progressive (2DIP) conversion, shown in FIG. 6, is applied. If “motion” is not detected, i.e., a “still” picture or image is detected, a 3DIP conversion is applied. However, malfunctions or errors tend to be caused by errors in motion detection. For example, if a motion detector detects an image containing “motion” as a “still” image, the IP converter applies 3DIP instead of 2DIP resulting in separated horizontal lines being observed in the displayed image. Therefore, it would be desirable to provide systems and methods that facilitate interlace-to-progressive signal conversion and eliminates or reduces the drawbacks noted above.

### SUMMARY

Embodiments described herein are directed to improved methods and systems that facilitate improved interlace-to-progressive signal conversion. In one embodiment, a television system adapted to provide enhanced interlace-to-progressive signal conversion includes a central processing unit (CPU) coupled to an audio-video output unit. The CPU preferably comprises non-volatile memory coupled to a logic unit which is adapted to receive and process a program signal S_{P} and, when a separated line is detected, output an enhanced program signal SEP to the audio-video output unit. The logic unit preferably includes a separated line detection circuit and a line regeneration circuit to correct the “separated line” effect due to errors in interlace-to-progressive signal conversion.

In operation, the program signal S_{P} is passed through the separated line detector circuit which detects whether there is sufficient correlation between n, n−2 and n+2 lines in the image. If there is strong correlation between line number n, n−2 and n+2, it detects these lines as separated. If a separated line is detected, the line regeneration circuit regenerates number n line from n−2 and n+2 line.

Other objects, systems, methods, features, and advantages of the invention will be or will become apparent to one with skill in the art upon examination of the following figures and detailed description. It is intended that all such additional systems, methods, features and advantages be included within this description, be within the scope of this invention, and be protected by the accompanying claims. It will be understood that the particular methods and apparatus are shown by way of illustration only and not as limitations. As will be understood by those skilled in the art, the principles and features explained herein may be employed in various and numerous embodiments.

### DESCRIPTION OF THE DRAWINGS

The details of the invention, both as to its structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a schematic diagram of a television system.

FIG. 2 is a schematic diagram of an embodiment of the logic unit of the television system shown in FIG. 1.

FIG. 3 is a schematic diagram showing the motion detection and I/P conversion circuits of the logic unit shown in FIG. 2.

FIG. 4 is a schematic diagram showing the logic of the separated line detection circuit of the logic unit shown in FIG. 2.

FIG. 5 is a schematic diagram showing the pixel mapping conduction by the line regeneration circuit of the logic unit shown in FIG. 2.

FIG. 6 is a schematic diagram showing a 2DIP conversion.

FIG. 7 is a schematic diagram showing a 3DIP conversion.

FIG. 8 is a schematic diagram showing enhanced 3DIP conversion.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

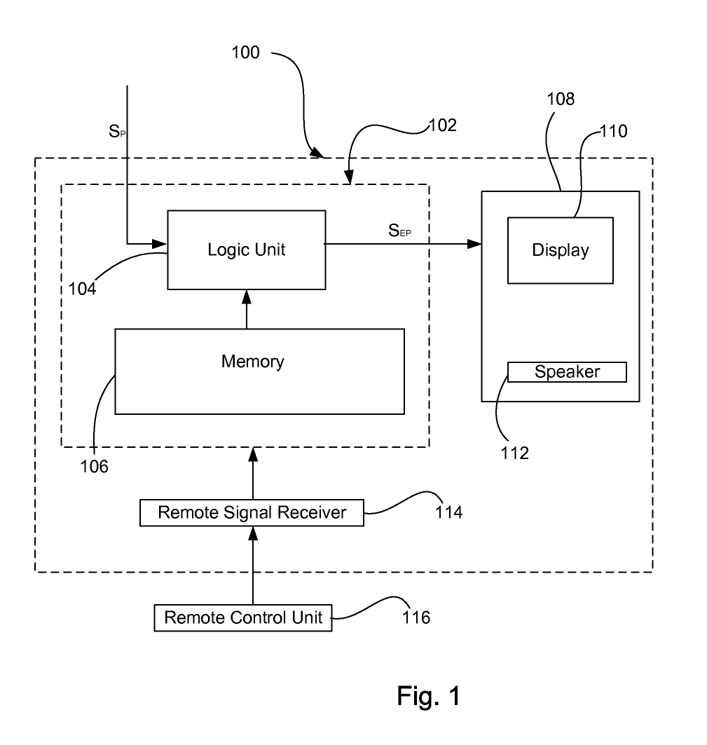

Embodiments described herein are directed to improved methods and systems for effectively improving television pictures through enhanced interlace-to-progressive conversion. Turning to figures, the embodiments provided herein are described in detail. In one embodiment, as depicted in FIG. 1, a television system 100 adapted to provide enhanced interlace-to-progressive conversion comprises a central processing unit (CPU) 102 coupled to an audio-video output unit 108 and a remote signal receiver 114, which is operably coupled to a remote control unit 116. The CPU 102 preferably comprises non-volatile memory 106 coupled to a logic unit 104 which is adapted to receive and process a program signal S_{P} and output an enhanced program signal S_{EP} to the audio-video output unit 108. The audio-video output unit 108 preferably includes a video display 110 for displaying the television picture or video component of the enhanced program signal S_{EP} and a speaker 112 for outputting the audio component of the enhanced program signal S_{EP} associated with the video component of enhanced program signal S_{EP}.

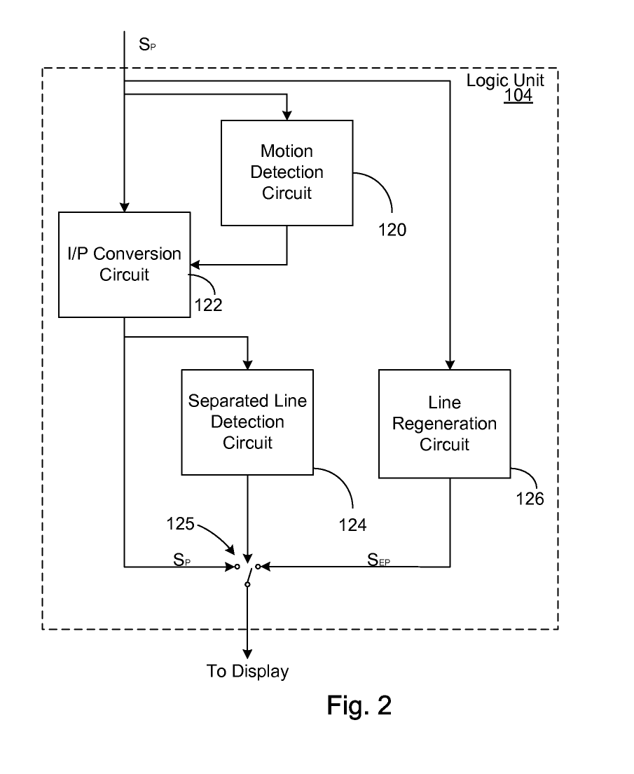

As depicted in FIG. 2, the logic unit 104, which corrects the “separated line” effect due to errors in interlace-to-progressive signal conversion, preferably includes a conventional motion detection circuit 120 and a conventional interlace to progressive conversion circuit 122 operably coupled to the motion detection circuit 120. In order to detect the occurrence of a separated line due to an error in the motion detection circuit 120 and regenerate the separated line, the logic unit 104 includes a separated line detection circuit 120 coupled to the I/P conversion circuit 122 and a line regeneration circuit 126 operably coupled to the separated line detection circuit 120.

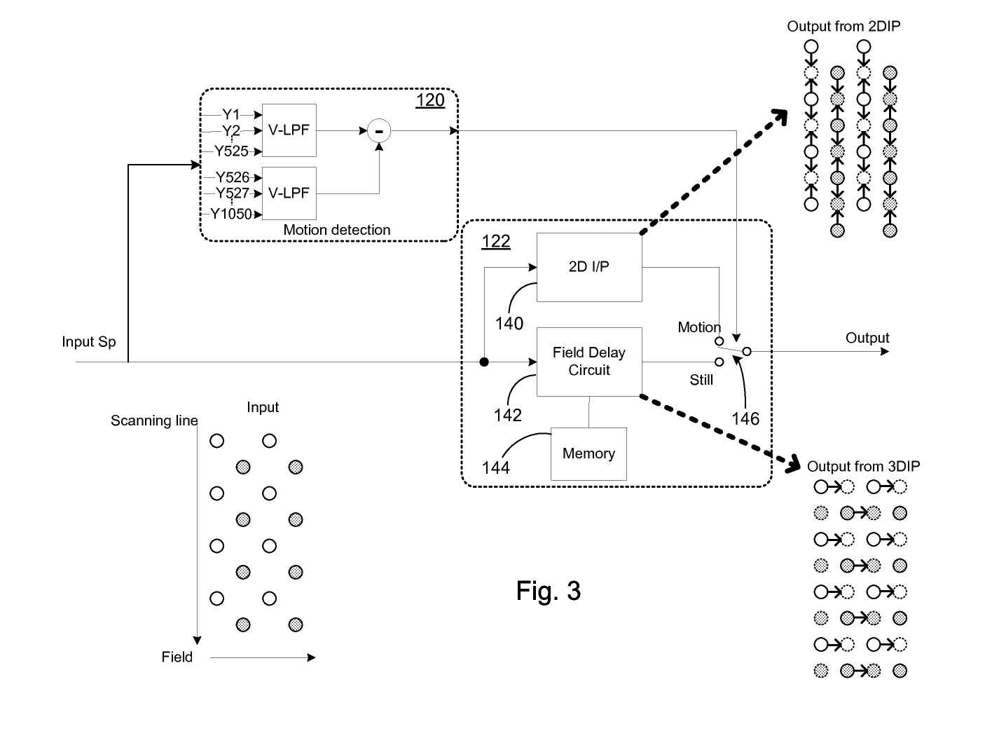

As shown in FIG. 3, the input signal Sp passes through the motion detection circuit 120 and the I/P conversion circuit 122, which includes a 2DIP circuit and a field delay circuit 142 coupled to memory 144. The outputs of the 2DIP circuit 140 and the field delay circuit 142 are operably coupled to the output of the IP conversion circuit 122 by a switch 146 that is positionable in response to the motion detection circuit 120. If the motion detection circuit 120 detects motion in the image, the switch 149 enables a 2DIP converted program signal outputted from the 2DI/P circuit 140 to be output from the I/P circuit 122. If the motion detection circuit 120 does not detect motion in the image, the switch 149 enables a 3DIP converted program signal outputted from the field delay circuit 142 to be output from the I/P circuit 122.

The I/P converted program signal S_{P} is then passed through the separated line detector circuit 124 which detects whether there is sufficient correlation between upper and lower lines in the image. If there is a strong correlation between line number n, n−2 and n+2, the lines are determined to be separated by the separated line detection circuit 120. If a separated line is detected, the line regeneration circuit 122 regenerates number n line from n−2 and n+2 line.

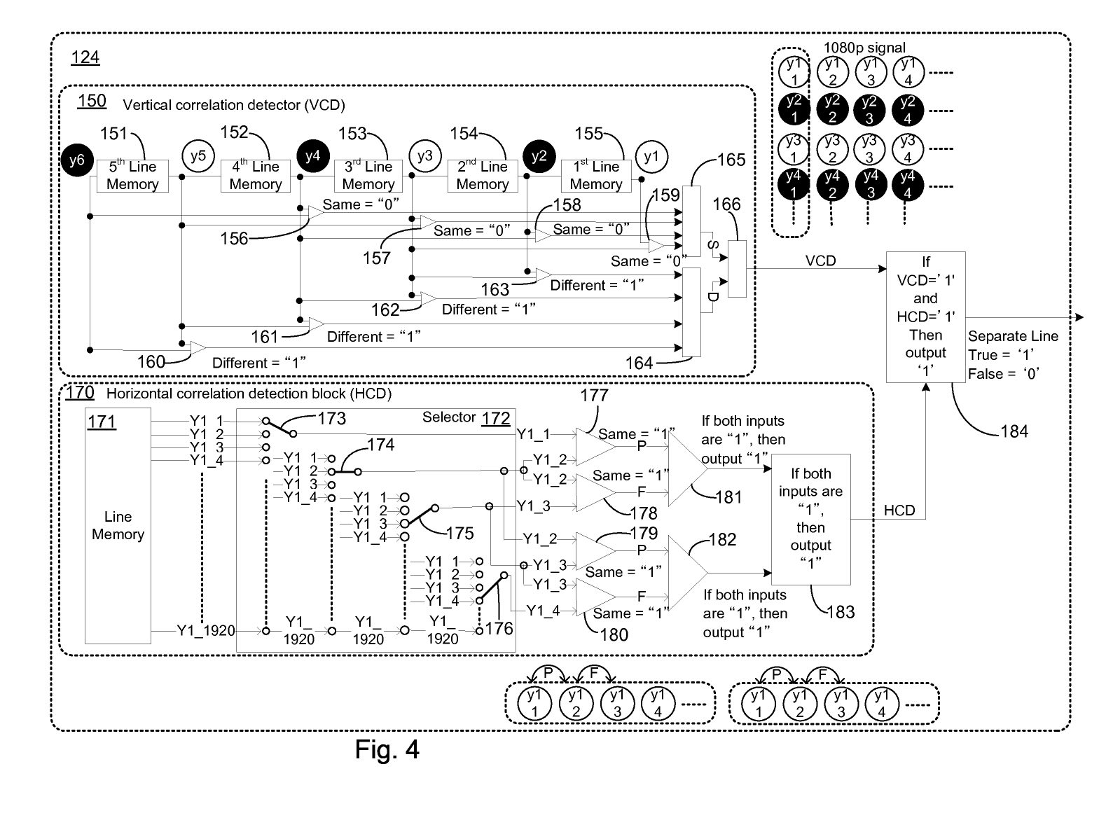

As shown in FIG. 4, in an example embodiment, the logic of the separated line detection circuit 124 includes a vertical correlation detection block (VCD) 150 and a horizontal correlation detection block (HCD) 170. As depicted in the example embodiment, the VCD 150 includes a series of line memory registers, 1st line memory 155, 2nd line memory 154, 3rd line memory 153, 4th line memory 152, and 5th line memory 151, into which the lines of the progressive scanned program signal Sp are successively read into. A first set of comparators 156, 157, 158 and 159 compare the Y signal (brightness) and/or C signal (color) of every other line, i.e., for example, the first comparator 156 compares the signals of lines Y6 and Y4, the second comparator 157 compares the signals of lines Y5 and Y3, the third comparator 158 compares the signals of lines Y4 and Y2, and the fourth comparator 159 compares the signals of lines Y3 and Y1. The comparators output a 0 if the signals of the compared lines are the same and a 1 if they are different.

A second set of comparators 160, 161, 162 and 164 compare the Y and/or C signals of adjacent lines, i.e., for example, the first comparator 160 compares the signals of lines Y6 and Y5, the second comparator 161 compares the signals of lines Y5 and Y4, the third comparator 162 compares the signals of lines Y4 and Y3, and the fourth comparator 163 compares the signals of lines Y3 and Y2. The comparators output a 1 if the signals of the compared lines are the different and a 0 if they are the same.

An S logic block 165 coupled to the first set of comparators determines whether all of the outputs of the comparators are 0s and outputs a 1 if each comparator output is a 0 and a 0 if not all outputs are a 0. A D logic block 164 coupled to the second set of comparators determines whether all of the outputs of the comparators are 1s and outputs a 1 if each comparator output is a 1 and a 0 if not all outputs are a 1. A logic block 166 coupled to the S and D logic blocks 165 and 164 determines whether the outputs of the S and D logic blocks 165 and 164 are 1s and outputs a 1 if each logic block output is a 1 and a 0 if not all outputs are a 1.

Once the comparisons are completed on the first set of lines, the next line in succession is moved into the comparison, while the lines in the previous comparison are successively read into the next memory register. For example, as depicted, the first comparison compares lines Y1, Y2, Y3, Y4, Y5 and Y6 with lines Y1, Y2, Y3, Y4 and Y5 read into the 1st, 2nd, 3rd, 4th and 5th line memory registers 155, 154, 153, 152 and 151 respectively. The next comparison will compare lines Y2, Y3, Y4, Y5, Y6 and Y7 with lines Y2, Y3, Y4, Y5 and Y6 read into the 1st, 2nd, 3rd, 4th and 5th line memory registers 155, 154, 153, 152 and 151, respectively, and so on until all lines have been compared.

As depicted in the example embodiment, the HCD 170 includes a line memory register 171 into which each line is successively read and a pixel selector 172 couple to the line memory 171. The selector 172 includes four selector switches 173, 174, 175 and 176 which successively select the pixels of the line stored in memory 171, for example, as depicted line Y1, in groups of 4 pixels until each pixel of the line has gone through the comparison process. For example, as depicted, selector switches 173, 174, 175 and 176 have selected pixels Y1_1, Y1_2, Y1_3 and Y1_4, respectively, of line Y1. After the comparison process is run on these four pixels, the selector 172 selects the next set of pixels to be compared. For example, the selector switches 173, 174, 175 and 176 will next select pixels Y1_2, Y1_3, Y1_4 and Y1_5, respectively, and so on, until all 1920 pixels have gone through the comparison process.

The comparison process is accomplished with first and second sets of comparators. The first set of comparators 177, 178, 179 and 180 compare the Y and/or C signals of first and second pixels to adjacent prior P and future F pixels. As depicted, comparator 177 compares Y1_2 to Y1_1, comparator 178 compares Y1_2 to Y1_3, comparator 179 compares Y1_3 to Y1_2, and comparator 180 compares Y1_3 to Y1_4. If the pixels are the same, the comparator outputs a 1 and a 0 if they are different.

The second set of comparators 181 and 182, compares the output of the P and F comparisons for a given pixel and outputs a 1 if the outputs of the P and F comparisons are both 1 and a 0 if they are different. Lastly, a logic block 183 determines if the output of the comparisons of the P and F comparison outputs for adjacent pixels are both 1 and outputs a 1 if they are the same.

Next, a logic block 184 is used to determine if the VCD and HCD outputs, i.e., the outputs from logic blocks 166 and 183, are both 1, which would indicate the occurrence of a separated line or line portion corresponding to the set of four pixels for which the HCD output currently corresponds. If a separated line is indicated, the logic block 184 will send a message to the switch 125, see FIG. 2, to select the output of the line regeneration circuit 126 to send to the display.

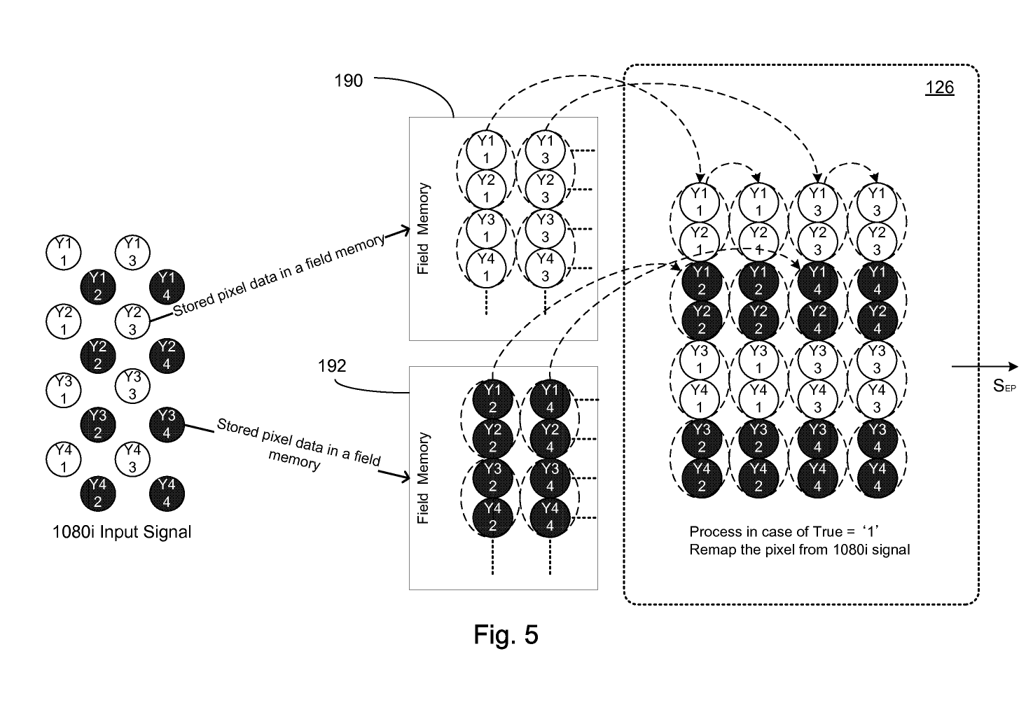

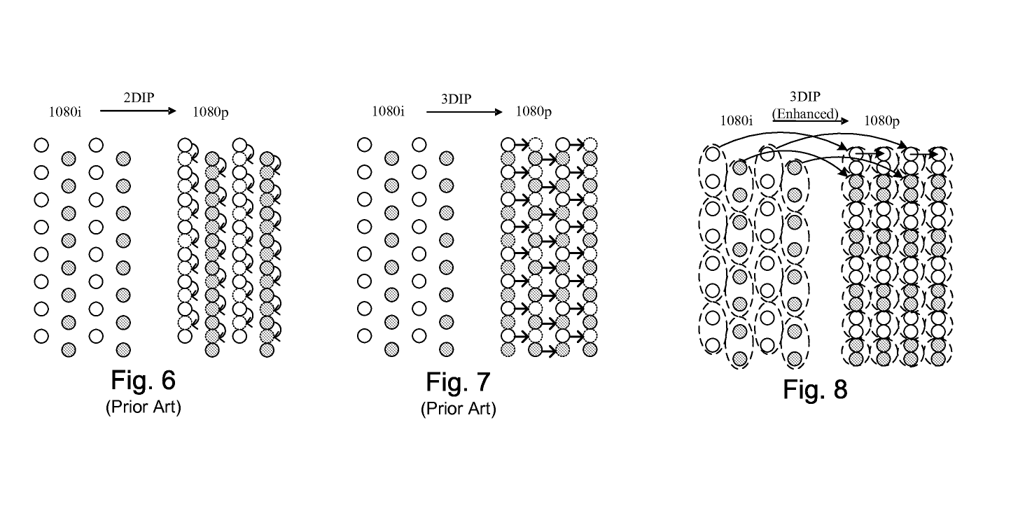

As depicted in FIG. 5, the line regeneration circuit 126 is configured to re-map the pixels of the 1080i program signal. The pixels are stored in first and second field memories 190 and 192. As depicted, the first pixel of lines Y1 and Y2, i.e., Y1_1 and Y2_1, of the first field, which is depicted as white, are re-mapped as the first pixels of the first and second lines of the progressive scan program signal with the second pixels of the first and second lines of the progressive scan signal being extrapolated from the first pixels. Similarly, the third pixels of lines Y1 and Y2 of the first field, i.e., Y1_3 and Y2_3, which is depicted as white, are re-mapped as the third pixels of the first and second lines of the progressive scan program signal with the fourth pixels of the first and second lines of the progressive scan signal being extrapolated from the third pixels. Next, the second pixel of lines Y1 and Y2, i.e., Y1_2 and Y2_2, of the second field, which is depicted as black, are re-mapped as the first pixels of the third and fourth lines of the progressive scan program signal with the second pixels of the third and fourth lines of the progressive scan signal being extrapolated from the first pixels. Similarly, the fourth pixels of lines Y1 and Y2 of the second field, i.e., Y1_4 and Y2_4, which is depicted as black, are re-mapped as the third pixels of the third and fourth lines of the progressive scan program signal with the fourth pixels of the third and fourth lines of the progressive scan signal being extrapolated from the third pixels. As shown in FIG. 8, this process continues as separated lines continue to be detected. The re-map pixels are output to the display as an enhanced progressive scan program signal Sep.

The particular examples set forth herein are instructional and should not be interpreted as limitations on the applications to which those of ordinary skill are able to apply the systems and methods described herein. Modifications and other uses are available to those skilled in the art which are encompassed within the spirit of the invention as defined by the scope of the appended claims.

What is claimed is:

1. A television system with program signal line separation correction, comprising
an audio-video output unit, and
a central processing unit (CPU) coupled to the audio-video output unit, the CPU comprising,
non-volatile memory, and
a logic unit coupled to the non-volatile memory and configured to convert an interlace program signal to a progressive signal and correct line separation defects in the converted program signal.

2. The television system of claim 1 wherein the program signal is a 1080i program signal.

3. The television system of claim 2 wherein the logic unit comprises
a line separation detection circuit, and
a line regeneration circuit operably coupled to the line separation detection circuit.

4. The television system of claim 3 wherein the line separation detection circuit adapted to detect correlations between at least a portion of line n and at least a portion of lines n−2 and n+2.

5. The television system of claim 4 wherein the adapted to regenerate at least a portion of line n if line separation is detected.

6. The television system of claim 3 wherein the line separation detection circuit includes a plurality of line memory registers and first and second set of comparators coupled to the plurality of line memory registers.

7. The television system of claim 6 wherein the first set of comparators are configured to compare a signal of line n with a signal of line n+2 and the signal of line n−2.

8. The television system of claim 7 wherein the second set of comparators are configured to compare the signal of line n with the signal of line n+1 and the signal of line n−1.

9. The television system of claim 8 wherein the signals being compared are Y signals.

10. The television system of claim 8 wherein the signals being compared are C signals.

11. The television system of claim 3 wherein the logic unit further comprises
a motion detection circuit, and
a interlace-to-progressive (I/P) conversion circuit operably coupled to the motion detection circuit.

12. The television system of claim 11 wherein the IP conversion circuit includes a 2DIP conversion component and a 3DIP conversion component.

13. A method for line separation defect correction comprising the steps of
converting an interlaced program signal to a progressive program signal,
detecting a line separation defect in the progressive program signal, and
regenerating a portion of a separated line corresponding to the line separation defect.

14. The method of claim 13 wherein the step of detecting a line separation defect includes
determining whether there is correlation between line n and lines n+2 and n−2,and
determining whether there is correlation between pixel m and pixels m−1 and m+1.

15. The method of claim 14 wherein the step of determining whether there is correlation between line n and lines n+2 and n−2 includes comparing the signal of line n with the signal of lines n+2 and n−2.

16. The method of claim 15 wherein the step of determining whether there is correlation between line n and lines n+2 and n−2 further comprising comparing the signal of line n with the signal of lines n+1 and n−1.

17. The method of claim 15 wherein the step of determining whether there is correlation between there is correlation between pixel m and pixels m−1 and m+1 includes comparing the signal of pixel m with the signal of pixels m−1 and m+1.

18. The method of claim 17 wherein the compared signal is a Y signal.

19. The method of claim 17 wherein the compared signal is a C signal.
